(19) United States
(12) Patent Application Publication
(10) Pub. No.: US 2011/0301726 A1
(43) Pub. Date: Dec. 8, 2011

(54) COMPUTERIZED BOWLING SYSTEM

(76) Inventor: Elvery P. Colquitt, SR., St. Louis, MO (US)

(21) Appl. No.: 13/152,716

(22) Filed: Jun. 3, 2011

Related U.S. Application Data
(60) Provisional application No. 61/351,507, filed on Jun. 4, 2010.

(51) Int. Cl. A63D 5/04; G06F 19/00

(52) U.S. Cl. 700/91; 473/54

(57) ABSTRACT

A computerized bowling system having an approach and an adjustable length bowling lane with a lane sensor arrangement in communication with a pin sensor area that collectively provide data on the release, spin and travel of the bowling ball down the lane is disclosed. The far end of the bowling lane includes a backstop area having a display as well as a ball return for returning the ball along a return gutter that runs adjacent the bowling lane. A processor communicates with the lane sensor arrangement and pin sensor area to collect and analyze data for providing corrective feedback to the user.

### CROSS-REFERENCE TO RELATED APPLICATIONS

This application claims benefit of U.S. Provisional Application No. 61/351,507 entitled “Computerized Bowling System” filed on Jun. 4, 2010, which is hereby incorporated by reference in its entirety.

### FIELD

The present document relates to a method and system for computerized bowling, and in particular to a computerized bowling system that provides corrective feedback to a bowler.

### BACKGROUND

The game of bowling is one of the most popular participant sports in the world, which is played by 95 million players in 90 different countries. Bowling is a sport in which players attempt to score points by rolling a bowling ball along a flat surface, usually a wood or synthetic surface, into objects called pins. Because of the popularity of bowling, many bowlers desire to practice and increase their bowling skills; however, without a bowling teacher in attendance the bowler has no practical means of being provided any corrective feedback to increase their bowling skills. In addition, there are no convenient modular bowling facilities that effectively simulate a bowling alley, such as a bowling lane, pin area, and automatic return for the bowler to practice his bowling skills in a home setting as well as provide corrective feedback to the bowler.

### SUMMARY

In one embodiment, a computerized bowling system for providing corrective feedback to a bowler may include a flat lane surface in communication with a backstop area having a pin sensor area that includes a plurality of pin sensors for representing a particular pin position in the pin sensor area. The backstop area further includes an automatic ball return and a plurality of lane sensors positioned along the flat lane surface with each of the plurality of lane sensors adapted to detect the travel of a bowling ball along the flat lane surface. A processor is in operative communication with the plurality of sensors and pin sensors for providing data to the processor. In addition, the computerized bowling system includes a monitor in operative communication with the processor for providing corrective feedback based on analysis of the travel of the bowling ball detected by the plurality of sensors and pin sensors, and the position of the bowler relative to a reference line entered into the processor.

In another embodiment, a computerized bowling system for providing corrective feedback to a bowler may include a flat lane surface in communication with a backstop area having a pin sensor area that includes a plurality of pin sensors for representing a particular pin position in the pin sensor area. The backstop area further includes an automatic ball return. In addition, a plurality of lane sensors are positioned along the flat lane surface with each of the plurality of lane sensors adapted to detect the travel of a bowling ball along the flat lane surface. A bowler corrective feedback system may include a processor, a memory, and a bowler corrective feedback application executed by the processor. In particular, the bowler corrective feedback application receives bowler profile data, wherein the bowler profile data identifies one or more bowler characteristics; receives bowler game play data from the plurality of lane sensors, pin sensors, and the flat lane surface; generates corrective feedback data based on the bowler profile data and the bowler game play data; and provides the corrective feedback at a display.

In an embodiment, a computer-readable medium encoded with an endorsement rebate application may include modules executable by a processor including a game play module to receive bowler profile data, wherein the bowler profile data identifies one or more bowler characteristics of a bowler, and bowler game play data from a plurality of pin sensors and a plurality of lane sensors; a corrective feedback generation module to generate corrective feedback for the bowler based on the profile data and the bowler game play data; and a display module to provide the corrective feedback to a display.

In yet another embodiment, a method for providing corrective feedback may includes receiving, at a processor, bowler profile data, the bowler profile data identifying one or more bowler characteristics. The method includes receiving, at the processor, bowler game play data from a plurality of pin sensors and a plurality of lane sensors. The method includes generating, at the processor, corrective feedback data based on the bowler profile data and the bowler game play data. The method further includes providing the corrective feedback at a display.

In one embodiment, a method for providing corrective feedback to a user may include: providing a flat lane surface defining an approach portion and a lane portion with a reference line that divides the lane portion from the approach portion, the lane portion in communication with a backstop area having a pin sensor area that includes a plurality of pin sensors for representing a particular pin position of a plurality of pin positions in the pin sensor area, a plurality of lane sensors positioned along the lane portion, each of the plurality of lane sensors adapted to detect a bowling ball traveling along the lane portion, a processor in operative communication with the plurality of lane sensors and pin sensors for providing data to the processor, a user interface in communication with the processor for permitting the user to interact with the processor, and a monitor in operative communication with the processor for providing a visual display. The method may include entering information into the processor related to the bowling ball and a position of a bowler relative to the reference line. The method may further include rolling a bowling ball along the flat lane surface toward the backstop area. The method may include detecting the travel, spin and speed of the bowling ball by the plurality of lane sensors and pin sensors. The method may include processing the data related to the travel, spin and speed of the bowing ball as the bowling ball travels along the lane portion as well as the position of the bowler relative to the reference line. The method may also include providing corrective feedback via the user interface based on the processed data.

Additional objectives, advantages and novel features will be set forth in the description which follows or will become apparent to those skilled in the art upon examination of the drawings and detailed description which follows.

### BRIEF DESCRIPTION OF THE DRAWINGS

FIG. 1 is a perspective view of a computerized bowling system;

FIG. 2 is a simplified plan view of a flat lane surface for the computerized bowling system;

FIG. 3 is a simplified plan view of the bowling lane shown in FIG. 2 illustrating the sensor arrangement used to detect the position of the bowler and the travel of a bowling ball down the flat lane surface;

FIG. 4 is a simplified block diagram illustrating the electronic components of the computerized bowling system;

FIG. 5 is a side view of the flat lane surface;

FIG. 6 is a perspective rear view of the flat lane surface;

FIG. 7 is an elevated rear view of a rear housing for a backstop area;

FIG. 8 is a front elevation view of the rear housing;

FIG. 9 is a partial cross-sectional view of the rear housing;

FIG. 10 is a side view of the rear housing;

FIG. 11 is a flow chart illustrating the method of using the computerized bowling system;

FIG. 12 is a diagram illustrating a reference system for entering the initial position of the bowler on the approach into a user interface of the computerized bowling system.

FIG. 13 is a simplified illustration showing corrective feedback related to the release, travel and trajectory through the pin sensor area by the computerized bowling system;

FIG. 14 is another simplified illustration showing the travel of the bowling ball down the flat lane surface for approaching the 1, 3 pocket in a pin sensor area;

FIG. 15 is a simplified illustration of the foul line;

FIG. 16 is a simplified illustration of the pin sensor area showing the respective pin sensors;

FIG. 17 is a block diagram of the bowler corrective feedback application according to one aspect of the corrective feedback system;

FIG. 18 is a flow chart illustrating the method of using the computerized bowling system; and

FIGS. 19-24 are example input forms for entering data into the bowler corrective feedback system.

Corresponding reference characters indicate corresponding elements among the view of the drawings. The headings used in the figures should not be interpreted to limit the scope of the claims.

### DETAILED DESCRIPTION

Aspects of the present disclosure include methods and systems for providing corrective feedback to a bowler. In particular, a computerized bowling system includes a computerized bowler corrective feedback system that receives bowling information from various components of a computerized bowling system. The corrective feedback system processes the bowling information and generates corrective feedback to a bowler that may be used to increase the bowler's skill level.

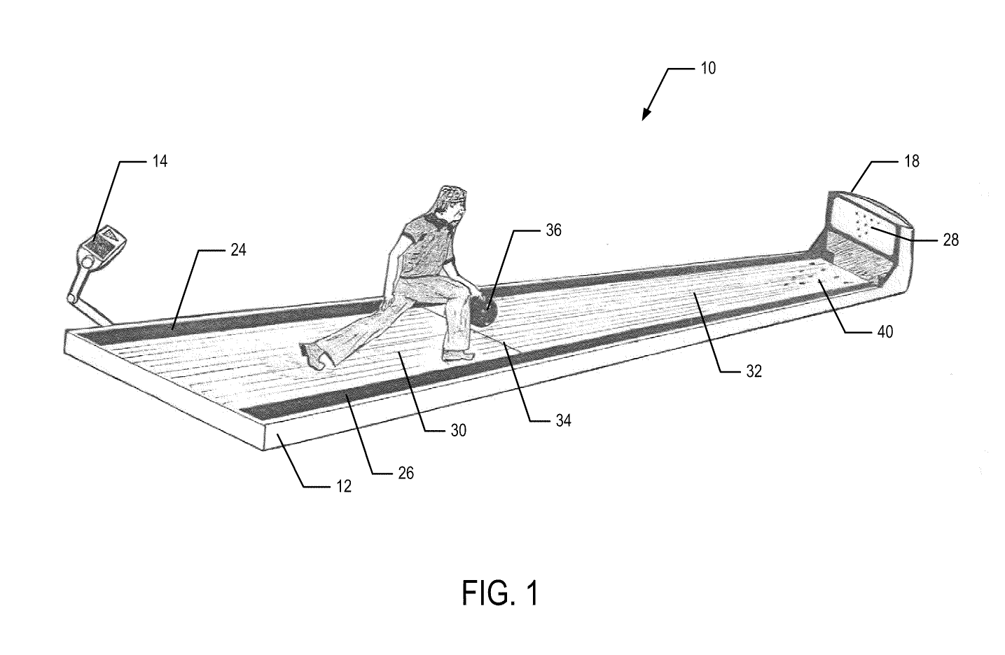

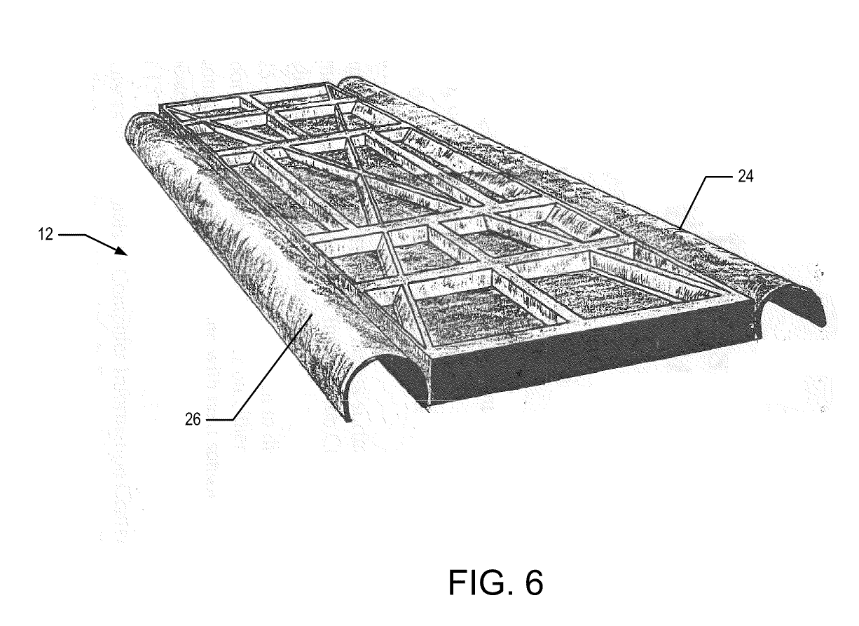

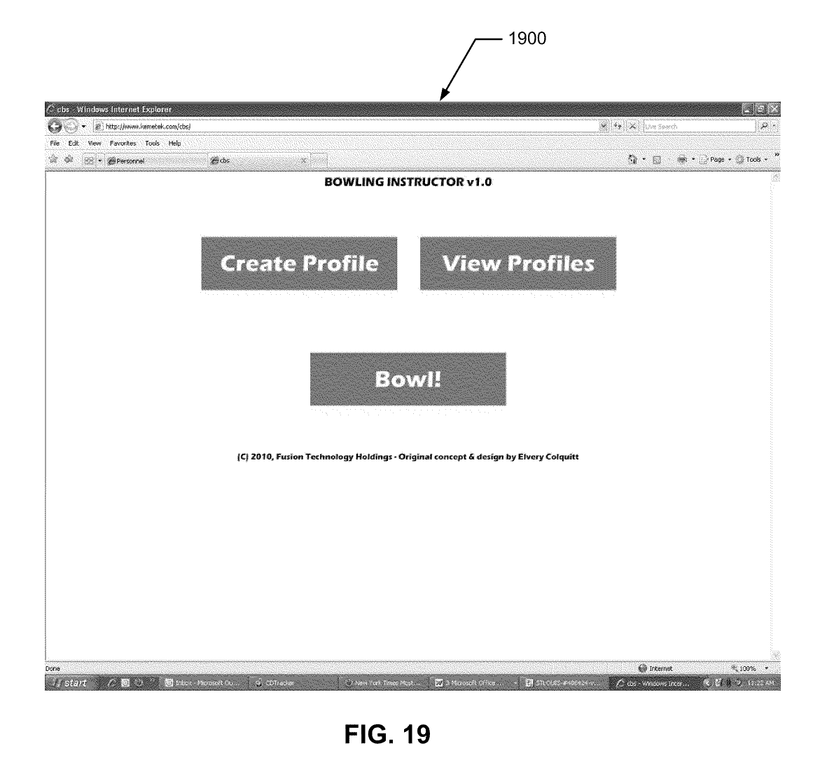

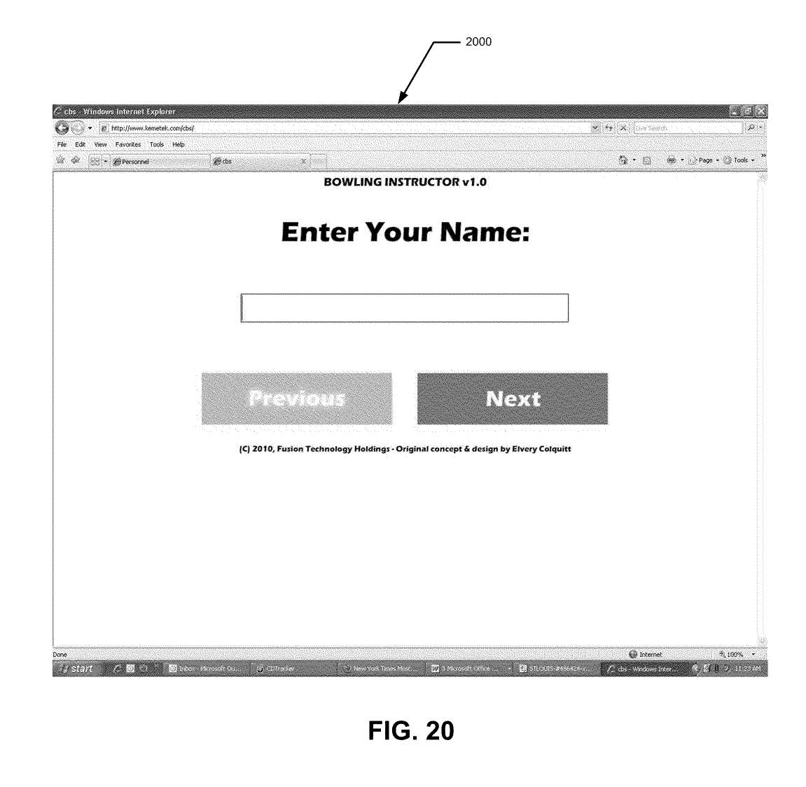

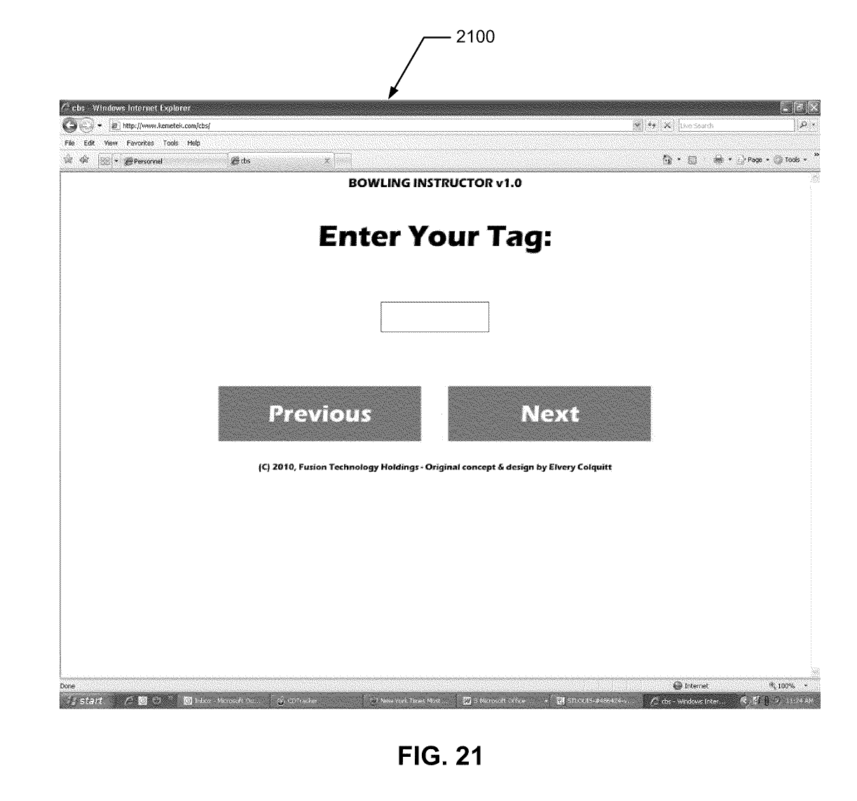

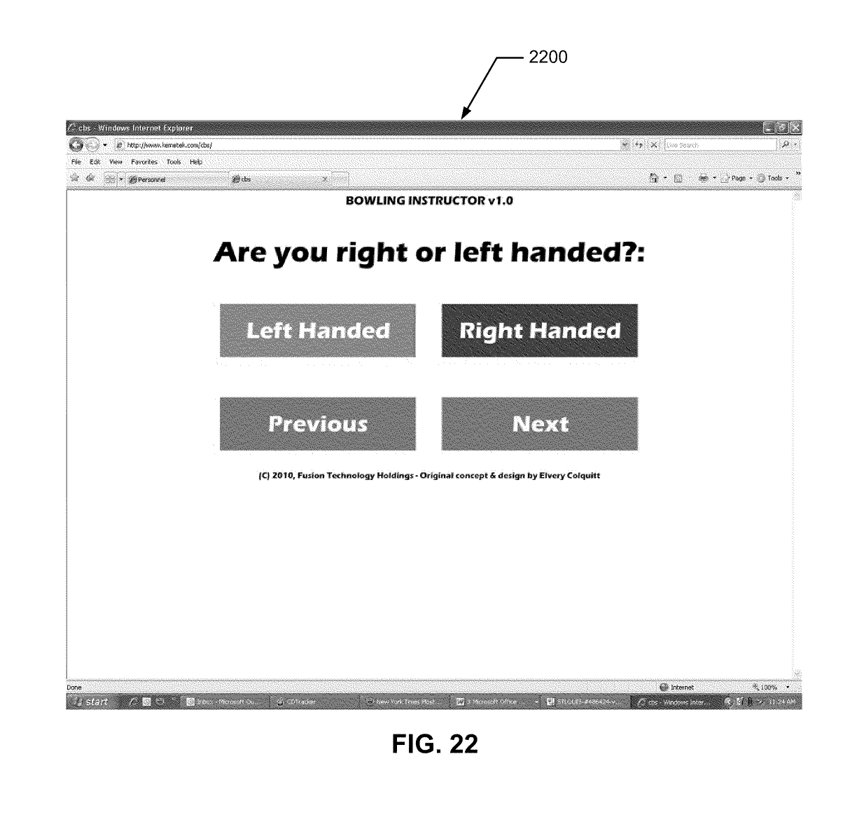

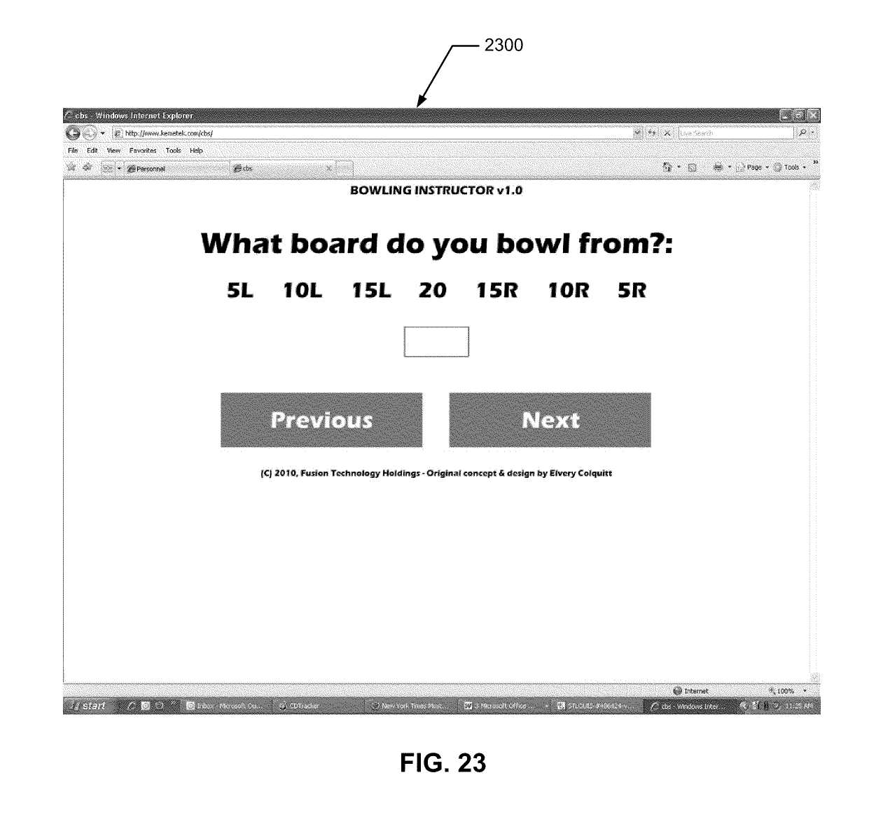

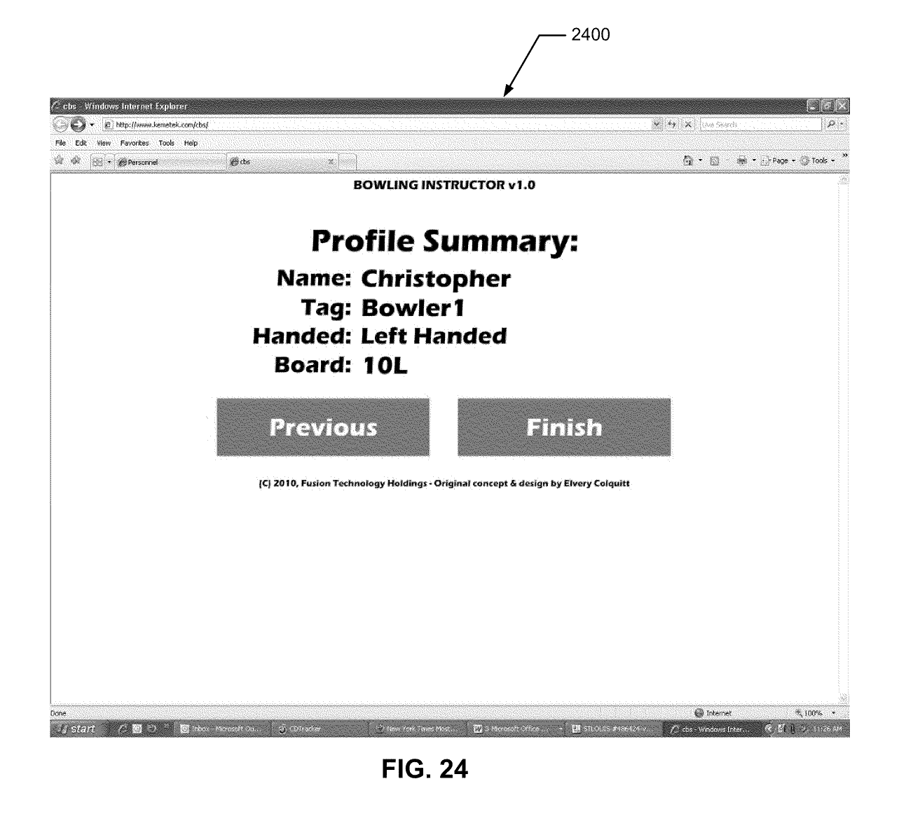

Referring to the drawings, an embodiment of a computerized bowling system is illustrated and generally indicated as 10 in FIGS. 1-24. As shown in FIGS. 1-4, the computerized bowling system 10 includes a flat lane surface 12 having the configuration of a conventional bowling lane, although the dimensions of the flat lane surface 12 may be modified to fit within the confines of a smaller area, such as a basement or garage. The flat lane surface 12 may include a plurality of lane portions that may be added or removed in order to shorten or lengthen the flat lane surface 12 to fit into the desired area. In one embodiment, the computerized bowling system 10 provides a means for playing or practicing a bowling game without the use of conventional bowling pins that would require a mechanical pin setter and sweeper arrangement to reset the pins.

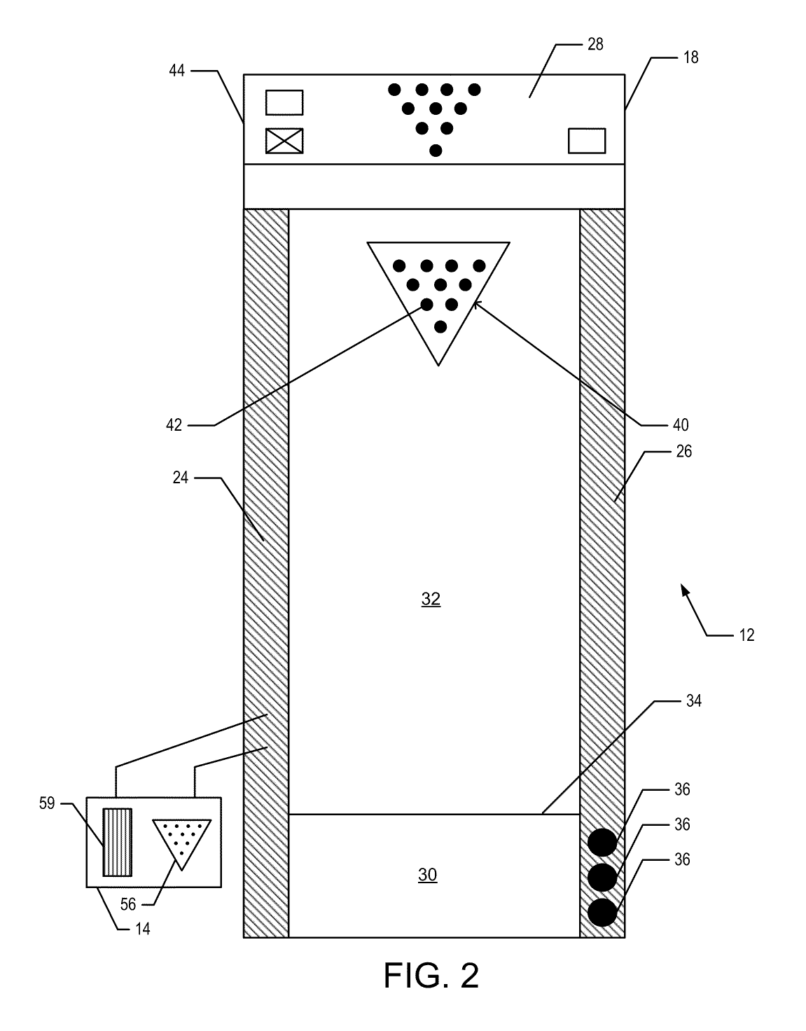

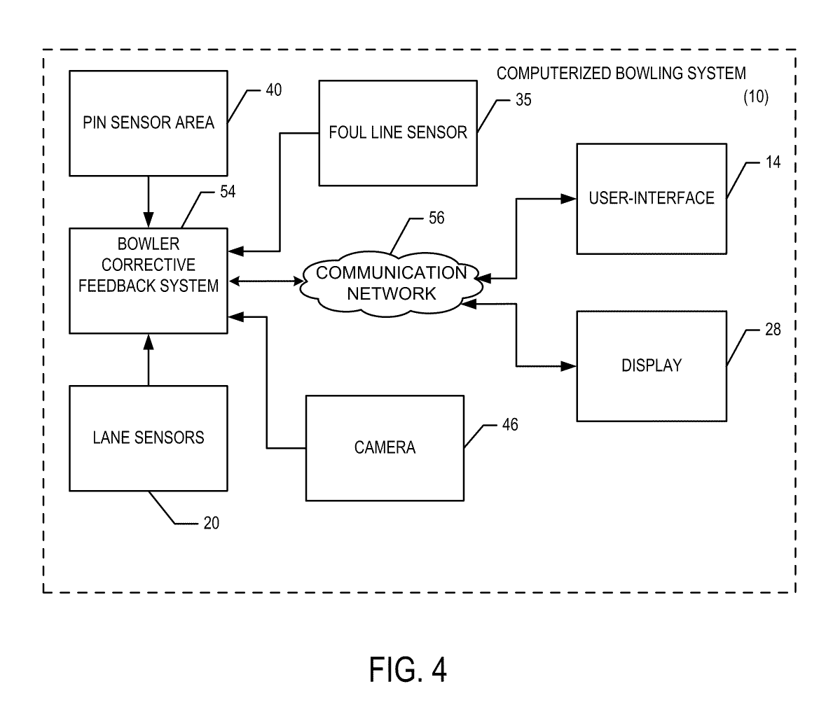

As shown in FIGS. 2, 3 and 16, pin sensors, designated 42A-J, are arranged within a pin sensor area 40 at the far end of the flat lane surface 12 which collectively act as a substitute for pins in a traditional pin arrangement such that the computerized bowling system 10 can determine the number of pins that would have been struck and displaced by the travel of the bowling ball 30 down the lane 32 and through the pin sensor area 40. Each of the pin sensors 42A-J represent a particular pin position of a ten pin arrangement used in a conventional bowling game. In addition, each of the pin sensors 42A-J communicate with a bowler corrective feedback system 54, as shown in FIG. 4, for providing data related to which pin sensors 42A-J were activated by the travel of a bowling ball 36 through the pin area 40 after release by the bowler. The bowler corrective feedback system 54 can determine the score of the bowler by virtue of the activation or non-activation of the respective pin sensors 42.

In one embodiment, the pin sensors 42 may be conventional pressure sensors that are activated when the bowling ball 36 makes contact with one or more of the pin sensors 42 during travel of the bowling ball 36 through the pin sensor area 40. In other embodiments, other types of sensors, such as LED sensors, may be used to detect the travel of the bowling ball 36 through the pin sensor area 40.

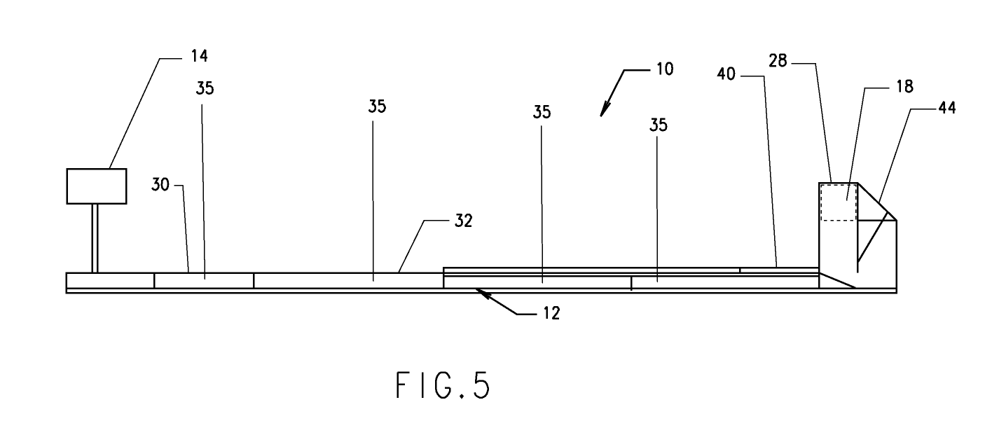

Referring to FIG. 2, the flat lane surface 12 includes an approach 30 and a lane 32 separated by a foul line 34 similar to conventional bowling lanes with the exception that the length of the lane 32 may vary from a conventional bowling lane depending on the number of lane portions assembled together and the space limitations of the area being used to set up the computerized bowling system 10. According to one aspect, the foul line 34 may be operatively connected to at least one foul line sensor 35 that detects when the ball 36 and/or bowler travels across the foul line 34. FIG. 5 illustrates that any number of lane portions may be assembled to provide a length for the lane 32 suitable for the surrounding area. Although the length of flat lane surface 12 may vary depending on the number of lane portions assembled, the corrective feedback provided to the bowler or calculation performed by computerized bowling system 10 is based on a standard full length bowling lane.

As further shown, the flat lane surface 12 includes a left gutter 24 that acts as a conduit for any bowling ball 36 that falls off the flat lane surface 32 and a right return gutter 26 that also functions as a conduit as well as a return for returning the bowling ball 36 after the bowling ball 36 has entered a backstop area 18 located at the far distal end of the flat lane surface 32. The backstop area 18 serves as a ball return for the bowling ball 36 as well as display area for a display 28 that displays various types of information to the bowler, such as score, bowler position, release point, bowler corrective data, and other relevant bowler information as shall be discussed in greater detail below. The display 28 is a device for viewing data, such as a computer monitor, television, or any other type of data display device. In one embodiment, the display may be a 40-inch wide screen monitor, although other different sized monitors are contemplated. In another embodiment, the display 28 is a touch-screen device that receives input from a bowler.

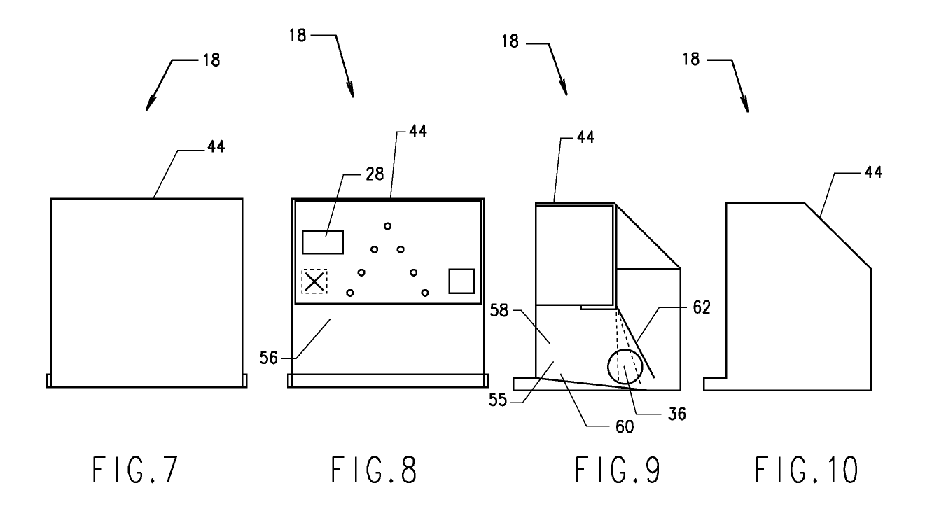

Referring to FIGS. 7-10, the backstop area 18 acts as a ball return as well as a display area for the bowler to view certain graphics and illustrations. The ball return function of the backstop area 18 permits the bowling ball 36 to be returned to the bowler through the right return gutter 26 after the bowling ball 36 has entered rear housing 44. The rear housing 44 defines a front entrance 55 that communicates with the flat lane surface 32 for permitting entry of the bowling ball 36 into the rear housing 44. The front entrance 55 communicates with a ball return area 58 defined by the rear housing 44 that includes a bottom slope portion 60 that facilitates the return of the bowling ball 36 via the right return gutter 26.

As shown in FIG. 9, the bottom slope portion 60 gradually tapers downwardly from the front entrance 55 toward the back portion of the rear housing 44 such that the bowling ball 36 rolls toward the back portion of the ball return area by force of gravity 58 after entering through the front entrance 55. In addition, the ball return area 58 includes a flap 62 that is adapted to slow the bowling ball 36 down once the bowling ball 36 enters the ball return area 58. After the bowling ball 36 passes through the flap 62, the bowling ball 36 is redirected to the return gutter 26 from the ball return area 58.

Referring back to FIGS. 2-4, the flat lane surface 12 includes a user interface 14 that provides a means for the bowler to interact with the with the bowler corrective feedback system 54. The user interface 14 may be a switch, button, keyboard, a touchpad, a touch screen, and/or a pointing device (e.g. a mouse, trackball, pen, or other device) for entering and navigating through data, including images, documents, structured data, unstructured data, HTML pages, other web pages, and other data. In one embodiment, the user interface 14 includes a push button arrangement 59 for entering information about the bowler or the bowling ball 36 as well as actuating various control functions of the with the bowler corrective feedback system 54. The user interface 14 also includes a graphics display 56 for displaying various graphics to the bowler, such as pin arrangement, travel of the bowling ball 36, bowler position, and ball release point, although other types of data for providing information, such as other types of corrective feedback, to the bowler is contemplated.

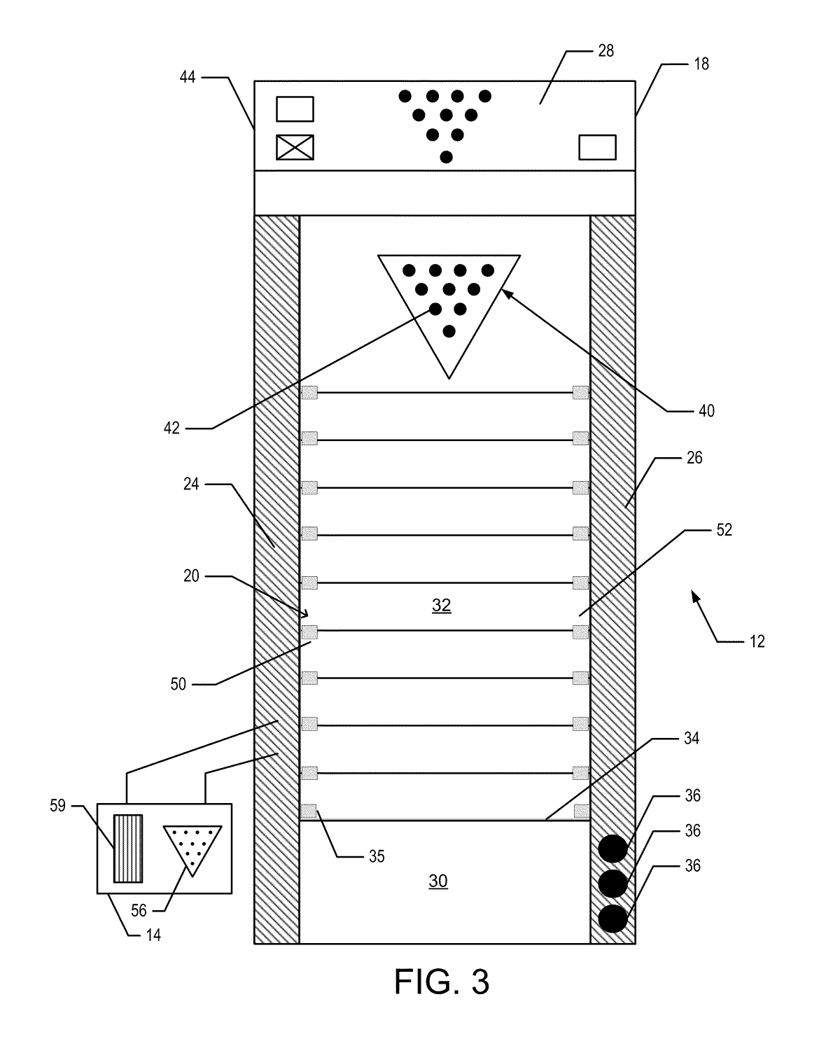

Referring to FIG. 3, the computerized bowling system 10 includes a lane sensor arrangement 20 located on both sides of the flat lane surface 32 for detecting the release point, spin and travel of the bowling ball 36 from the foul line 34 to the backstop area 18. In one embodiment, each sensor arrangement 20 includes an infrared transmitter 50 that generates and transmits a beam of light from a light source, such as a Light Emitting Diode (LED), to a respective infrared receiver 52 that detects the beam of light. In one embodiment, the infrared transmitters 50 may be spaced at intervals of 12 inches along the length of the lane 32, although the transmitters 50 and respective receivers 52 may be spaced at any suitable interval that provides sufficient data related to the ball speed, travel and spin as the bowling ball 36 travels down the lane 32 for analyzing the particular dynamic characteristics of the bowling ball 36 during travel. The release, spin and travel of the bowling ball 36 down the lane 32 is detected by the sensor arrangement 20 as the bowling ball 36 progressively breaks the beams of light established at consecutive locations along the lane 32 by each respective pair of detectors, e.g., infrared transmitter 50 and infrared receiver 52 combination, positioned on either side of the flat lane surface 32.

FIG. 4 is a simplified block diagram illustrating the relationship between the various components of the computerized bowling system 10. The computerized bowling system 10 includes a user interface 14, a display 28, a pin sensor area 40, a camera 46, lane sensors 20, a bowler corrective feedback system 54, and a communication network 56.

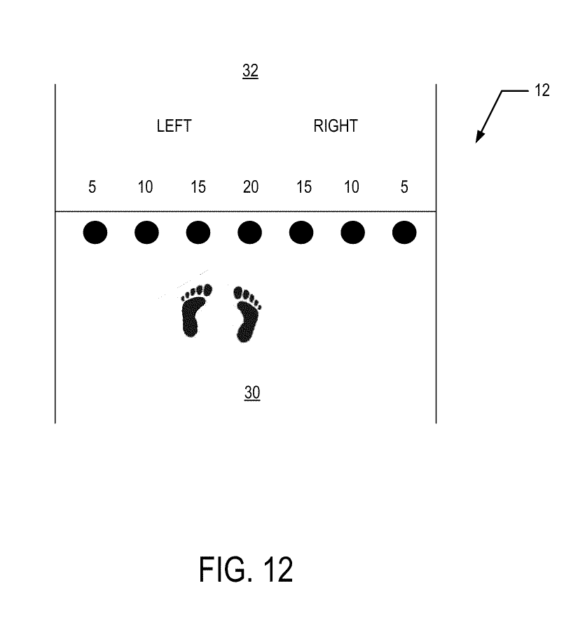

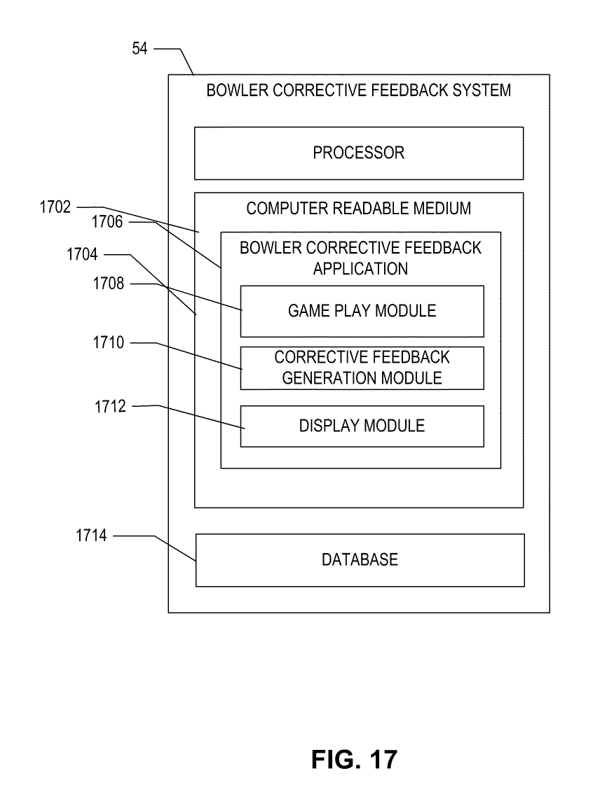

According to one embodiment, a bowler interested in receiving corrective feedback during a bowling game from the bowler corrective feedback system 54, uses the user interface 14 to generate a request for entering bowler profile data. The bowler corrective feedback system 54 transmits a bowler profile data entry form to display at the user interface 14 in response to the bowler profile data entry request. The bowler then uses, for example, the keyboard associated with the user interface 14 to interact with the bowler profile data entry form to enter bowler profile data. Bowler profile data identifies specific characteristics of a bowler and may include data such as the bowler's name and/or a fictitious bowler name, the bowlers bowling hand, and the data regarding the bowler's initial standing position. The bowler may then enter the bowler profile data such as the specification of his bowling ball 36, and/or particular weight of the bowling ball 36. In another embodiment, the bowler may enter other bowler profile data such as information related to the bowler's initial feet position along the reference line shown in a diagram illustrated in FIG. 12. The lane width and length of the lane 32 may also be entered along with a target spot, such as a particular pocket in the pin sensor area 40, that the bowler wants to strike with the bowling ball 36. After entering the bowler profile data, the bowler uses the user interface 14 to select an input control, such as a submit control button displayed on the bowler profile data entry form to transmit the bowler profile data to the bowler corrective feedback system 54. For purposes of illustration, various bowler profile data entry forms are shown in FIGS. 17-24.

According to another embodiment, the user interface 14 may be a computing device external to the flat lane surface 12 and the computerized bowling system 10 such as a computer, a processing device, a communication device, a personal computer, a server computer, a tablet computer, a mobile processing device, a mobile communication device, etc (not shown). The computing device includes one or more processors that process software or other machine-readable instructions and includes a memory to store the software or other machine-readable instructions and data. The memory may include volatile and/or non-volatile memory. The computing device may also include a communication system to communicate via a wireline and/or wireless communications, such as through the Internet, an intranet, and Ethernet network, a wireline network, a wireless network, and/or another communication network.

The computing device communicates with the bowler corrective feedback system 54 via the communication a network 56. The communication network 56 can be the Internet, an intranet, a local area network, a wireless local network, or another communication network, as well as combinations of networks. In another embodiment, each computing device may be coupled or communicatively connected to the bowler corrective feedback system 54 from a remote location, such as by a wide area network or via the Internet. For example, the computing device may communicate with the bowler corrective feedback system 54 through a private network. In another embodiment, the computing device may communicate with the bowler corrective feedback system directly, such as through an Ethernet cable. A bowler uses the computing device similar to the user interface 14 and the display 28 described above when entering bowler profile data.

The pin sensor area 40, the lane sensors 20, and the camera 46 all provide bowler game play data to the bowler corrective feedback system 54. As will be described in further detail below, bowler game play data includes any data relating to bowling during actual bowling game play, provided by the various components within the computerized bowling system 10. In one embodiment, the sensor arrangement 20 is in operative communication with the bowler corrective feedback system 54 for providing bowler game play data from each respective pair of infrared transmitters 50 and infrared receivers 52 regarding the release, spin and travel of the bowling ball 36 down the lane 32. In another embodiment, the camera 46 may provide bowler game play data such as video feedback to the bowler corrective feedback system 54.

Once the bowler profile data and bowling game play data has been received by the bowler corrective feedback system 54, the bowler corrective feedback system 54 analyzes the bowler profile data and bowler game play data to generate and provide corrective feedback data to the bowler.

FIG. 17 is block diagram that depicts the bowler corrective feedback system 54. The bowler corrective feedback system 54 includes a processor 1702 that executes a bowler corrective feedback application 1706 that generates and provides corrective feedback data to the bowler based on the bowler profile data and the bowler game play data received. The processor 1702 may include memory as well as other computing components and may reside on a computer, or other processing system.

The bowler corrective feedback system 54 may also include a computer readable media (“CRM”) 1704 configured with the bowler feedback application 1706. The CRM 1704 may include memory, volatile media, nonvolatile media, removable media, and non-removable media. For example, the CRM may include computer storage media. Computer storage media may include memory, volatile media, nonvolatile media, removable media, and/or non-removable media implemented in a method or technology for storage of information, such as a computer readable instructions, data structures, program modules, or other data.

The bowler corrective feedback system 54 may include a database 1714 to store bowler profile data, bowler game play data, corrective feedback data, and/or other data. The database 1714 may include memory and one or more processors or processing systems to receive, process, query and transmit communications and store and retrieve data. In another aspect, the database 1714 may be a database server.

The bowler corrective feedback application 1706 includes instructions or modules that are executable by the processor 1702. For example, in one embodiment, the bowler feedback application 1706 includes a game play module 1708, a corrective feedback generation module 1710, and a display module 1712. Other modules may also be included.

The game play module 1708 receives bowler profile data from a bowler through the user interface 14. For example, the game play module 1708 may receive bowler profile data indicating the bowler's name, bowler's fictitious name/tag, and bowling hand from the user interface 14. The game play module 1708 also receives bowler game play data. Bowler game play data includes any data relating to bowling during actual bowling game play, provided by the various components within the computerized bowling system 10. For example, the game play module 1708 may receive data regarding the release, spin, and travel of the bowling ball from the sensor arrangement 20, the infrared transmitters 50, and infrared receivers 52.

The game play module 1708 may also receive bowler game play data such as video data from the camera 46. For example, the game play module 1708 may receive bowler game play data from the camera 46 indicating the position of the bowler's footing relative to the reference line that runs along the foul line 34, the release point of bowling ball 36, the travel of the bowling ball 36 down the flat lane surface 32, and the trajectory of the bowling ball 36 through the pin sensor area 40. Such video feedback may also include recommended release points, bowler position relative to the reference line established along the foul line 34, whether a certain spin or speed of the bowling ball 36 should be achieved, and whether a particular bowler posture should be assumed. The bowler game play module 206 may receive other corrective information that may be relayed by the data collected by the camera 46, lane sensor arrangement 20 and/or pin sensor area 40. Accordingly, any type of bowling data generated during game play may be received by the game play module 1708 as bowler game play data. The game play module 1708 stores the bowler profile data and the bowler game play data in the database 1714.

The corrective feedback generation module 1710 analyzes the bowler profile data and bowler game data received by the game play module 1708 and generates corrective feedback data. Corrective feedback data refers to any type of data that may be used to increase a bowler's bowling skill. For example, corrective feedback data may include bowling scores, pin counts, bowling ball weight data, bowling ball spin data, bowling ball placement data, bowling ball revolution data, bowling lane width and length data, bowling lane slot data, aiming point data, etc. Additionally, corrective feedback data may indicate: bowler feet placement on the lane relative to the line that runs along the foul line 34; information indicating which bowling lane board the bowling ball should travel down on the flat lane surface 32; information indicating which pins to aim toward through the pin sensor area 40; information relating to the proper trajectory path of the bowling ball 36 through the pin sensor area 40; proper bowling ball 36 speed; proper release point of the bowling ball 36; etc.

For example, a bowler may be attempting to increase the number of strikes bowled. Thus, the corrective feedback generation module 1710 may generate corrective feedback data indicating that a right handed bowler should roll his bowling ball over bowling lane board 12 R hooking down the lane toward the 1, 3 pocket in order to increase his change of bowling a strike. As another example, a bowler may be confronted with a 4-5-7 pin split. In response, the corrective feedback generation module 1710 may generate corrective feedback data indicating that a right handed bowler should fit his bowling ball between the two front pins, rolling the ball over bowling lane board 10 R to hit pins 4 and 5, causing pin 4 to knock over pin 7. In yet another example, the corrective feedback generation module 1710 may generate corrective feedback data in the form of a video. For example, the corrective feedback generation module 1710 may generate video corrective feedback data indicating the proper positioning of the recommended release points, bowler position relative to the reference line established along the foul line 34, whether a certain spin or speed of the bowling ball 36 should be achieved, and whether a particular bowler posture should be assumed.

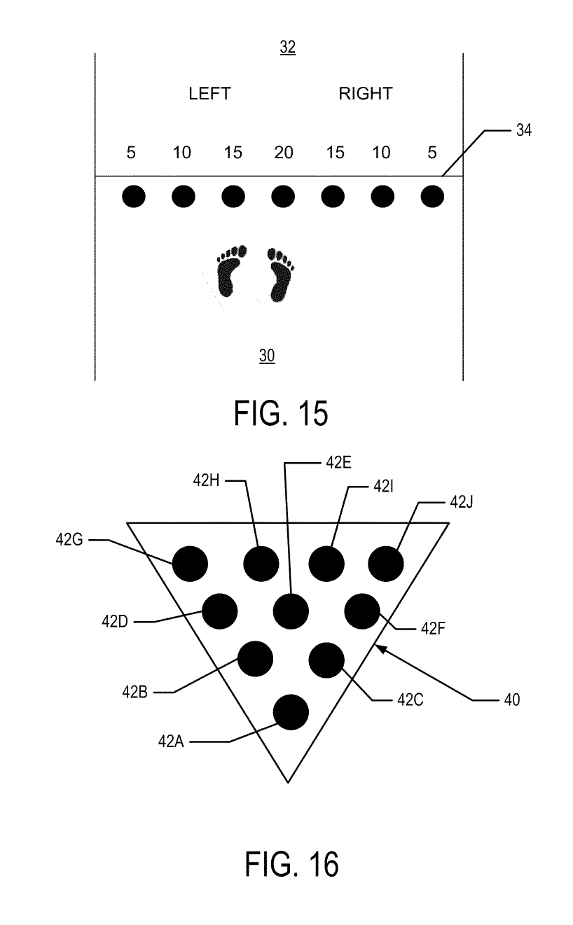

In one embodiment, the corrective feedback generation module 1710 may generate any type of corrective feedback data capable of increasing a bowler's skill, by analyzing bowler profile data and bowler game data. The corrective feedback generation module 1710 may, for example, determine that an adjustment in the weight of the bowling ball 36 is needed and/or a different brand of bowling ball 36 is required. The corrective feedback generation module 1710 may determine whether an adjustment to the bowler's position relative to the reference line is required as shown in FIG. 15. In one embodiment, the corrective feedback generation module 1710 may provide instructions to the bowler for making particular shots relative to particular pins, such as sour apple or Lily shots (5-7-10), baby split shot (2-7), cocked hat shots (2-7-10 and 3-7-10), big four shots (4-6-7-10) side by side splits (2-3, 4-5, 5-6, 7-8, 8-9, 9-10), and, fit split shots (4-5-7 and 5-6-10), Greek Cathedral shots (2-4-6-7-8 and 3-4-6-7-9-10), big five shots (3-4-6-7-10), and other types of splits (4-7-10 and 6-7-2). The instructions for making the above shots are described in greater detail in the attachment to the detailed description herein incorporated by reference in its entirety.

In yet another embodiment, the corrective feedback generation module 1710 may identify certain problems raised by the certain actions of the bowling ball 36. For example, when the bowling ball 36 is hooking or rolling too early, the solution would be instructions to increase the speed of the bowling ball 36 down the lane 32, while when the bowling ball 36 is skidding too much or not hooking down the lane 32, the solution would be to decrease the speed of the bowling ball 36. In one embodiment, the speed of the bowling ball 36 may be calculated by using the equation:

$$\frac{Total Distance}{Total Time Taken} .$$

wherein

$$Speed ( V ) = \frac{d}{t}$$

The display module 1712 provides the corrective feedback data generated by the corrective feedback generation module 1710 for display at the display 28 or the user interface 14. In one embodiment, the display module 1712 may provide the corrective feedback data as an output form comprising textual data and/or visual data, such as graphical displays, charts, and/or video, or a combination thereof. For example, the display module 1712 may provide an illustration of the corrective feedback data for display on the user interface 14 or the display 28 depicting how to correct a certain ball trajectory or achieving a certain shot, such as making a spare or a split. As another example, the display module 1712 may provide corrective feedback data in the form of video received from the camera 46 for display on the user interface 14 and/or the display 28.

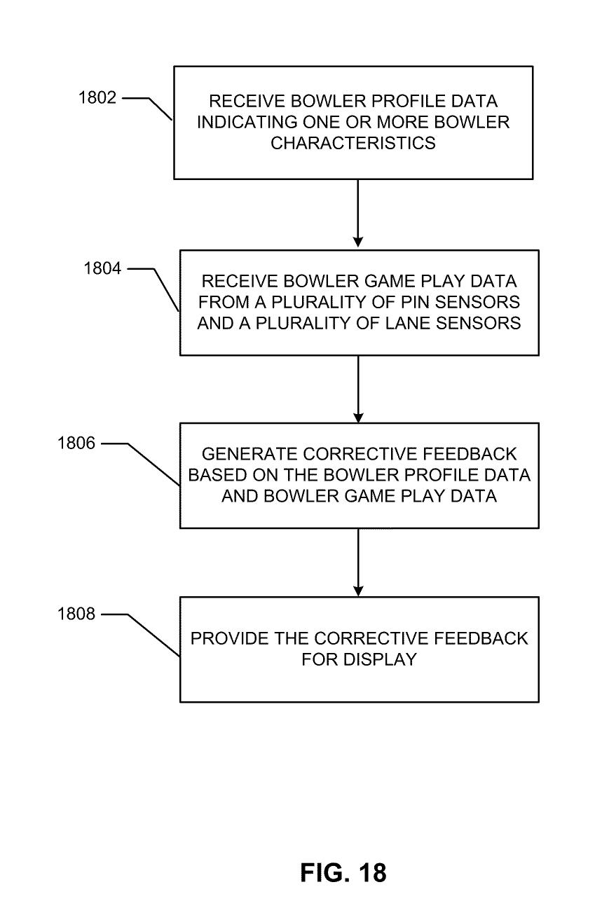

FIG. 18 depicts an example flow chart for providing corrective feedback to a bowler according to an example embodiment. At block 1802, bowler profile data indicating one or more bowler characteristics is received. Bowler game play data is received from a plurality of pin sensors and a plurality of lane sensors at block 1804. At block 1806, corrective feedback is generated by analyzing the bowler profile data and the bowler game play data. At block 1808, the corrective feedback is provided to a bowler for display.

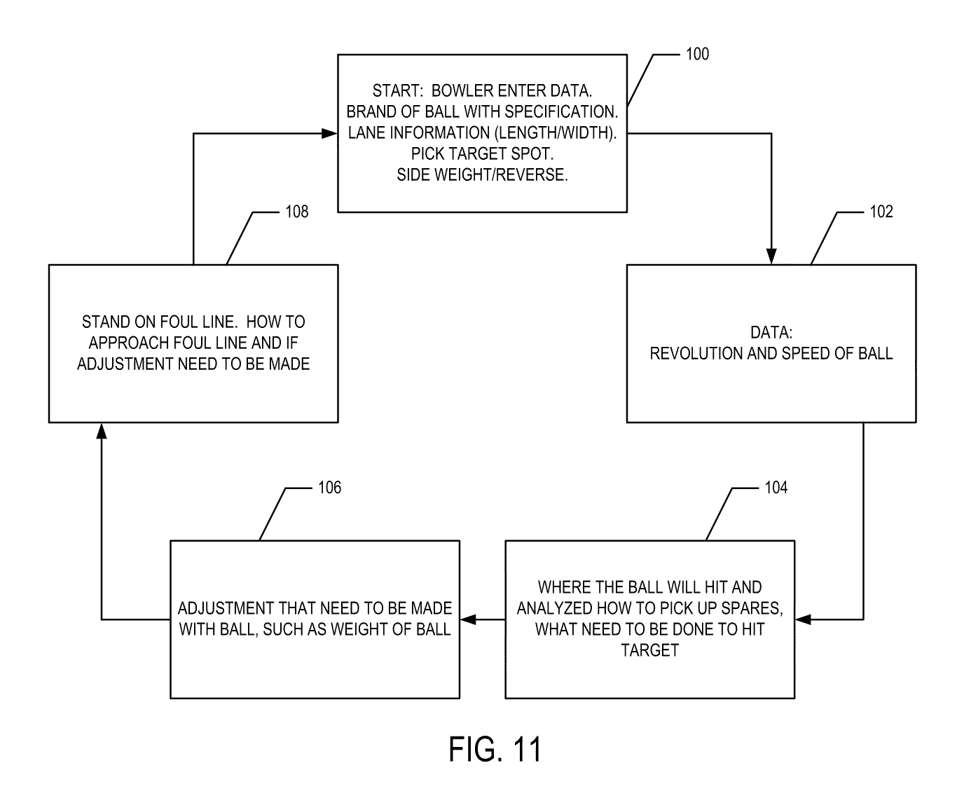

FIG. 11, is another example flow chart illustrating the steps of using the computerized bowling system 10. At step 100, the bowler enters data through the user interface 14 for processing by the bowler corrective feedback system 54. In one embodiment, the bowler enters bowler profile data such as his name, or a fictitious name, and then enters the specification of his bowling ball 36, such as the ball brand and particular weight of the bowling ball 36. Once the bowler profile data is entered, the bowler enters information related to his initial position along the reference line shown in a diagram illustrated in FIG. 12. The lane width and length of the flat lane surface 32 is then entered along with a target spot, such as a particular pocket in the pin sensor area 40, that the bowler wants to strike with the bowling ball 36.

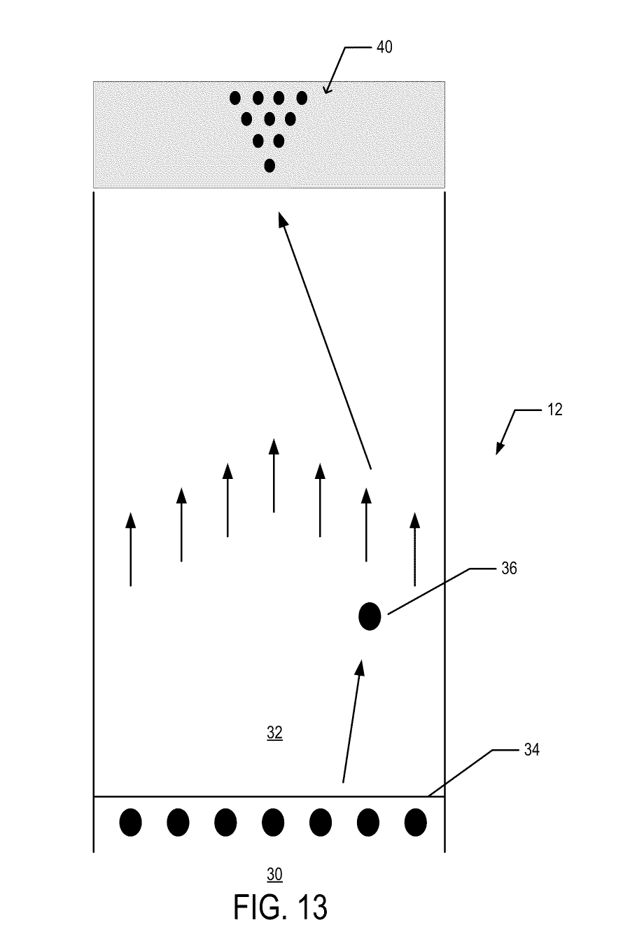

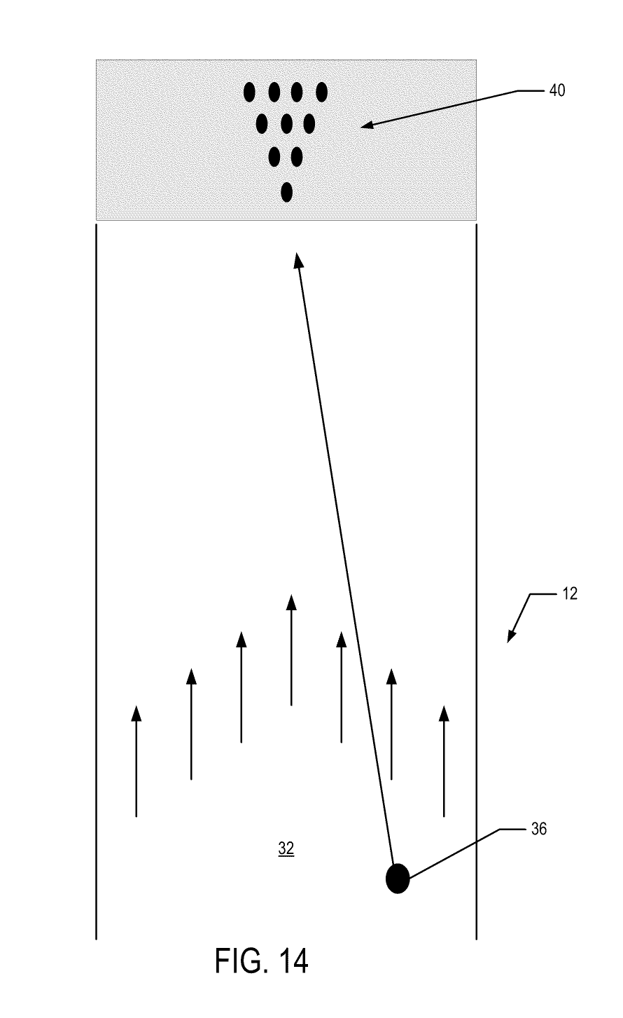

Once the data is entered into the user interface 14, the bowler may be positioned at the location relative to the reference line and then release the bowling ball 36 down the lane 32. At step 102, data is collected by the lane sensor arrangement 20 and pin sensor area 40 as the bowling ball 36 travels down the lane 32 and is communicated to the processor 16. At step 104, the bowler corrective feedback system 54 analyzes the collected data to determine which pin sensor(s) 42, if any, are triggered by the bowling ball 36 as the bowling ball 36 travels through the pin sensor area 40. In addition, bowler corrective feedback system 54 may provide corrective feedback data to the bowler through either the user interface and/or display 28 in an illustration shown in FIGS. 13 and 14, which show the recommended approach position and lane slot for achieving a particular shot.

At step 106, bowler corrective feedback system 54 may determine that an adjustment in the weight of the bowling ball 36 is needed and/or another brand of bowling ball 36 is required, while at step 108 bowler corrective feedback system 54 determines whether an adjustment to the bowler's position relative to the reference line is required as shown in FIG. 15, and if so, provides corrective feedback data in the form of an illustration on the display 28 or the user interface 14 for correcting a certain ball trajectory or achieving a certain shot, such as making a spare or a split.

The description above includes example systems, methods, techniques, instruction sequences, and/or computer program products that embody techniques of the present disclosure. However, it is understood that the described disclosure may be practiced without these specific details.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may, in part, be provided as a computer program product, or software, that may include a machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium (e.g., floppy diskette), optical storage medium (e.g., CD-ROM); magneto-optical storage medium, read only memory (ROM); random access memory (RAM); erasable programmable memory (e.g., EPROM and EEPROM); flash memory; or other types of medium suitable for storing electronic instructions.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

Those skilled in the art will appreciate that variations from the specific embodiments disclosed above are contemplated by the invention. The following invention should not be restricted to the above embodiments, but should be measured by the following claims.

What is claimed is:

1. A computerized bowling system for providing corrective feedback to a bowler comprising:
a flat lane surface in communication with a backstop area having a pin sensor area that includes a plurality of pin sensors for representing a particular pin position in the pin sensor area, the backstop area further includes an automatic ball return;
a plurality of lane sensors positioned along the flat lane surface, each of the plurality of lane sensors adapted to detect the travel of a bowling ball along the flat lane surface; and
a bowler corrective feedback system comprising:
a processor;
a memory; and
a bowler corrective feedback application executed by the processor to:
receive bowler profile data, the bowler profile data identifying one or more bowler characteristics;
receive bowler game play data from the plurality of lane sensors, pin sensors, and the flat lane surface;
generate corrective feedback data based on the bowler profile data and the bowler game play data; and
provide the corrective feedback at a display.

2. The system of claim 1, further comprising a foul line sensor to detect whether a ball is placed in front of a foul line.

3. The system of claim 1, wherein the display is user interface incorporated into the flat lane surface.

4. The system of claim 1, wherein the display is an electronic mobile device.

5. The system of claim 1, wherein the bowler profile characteristics comprises bowler name, bowler tag, and bowler hand.

6. The system of claim 1, wherein the game play data specifies the travel path and speed of a bowling ball, the game profile data comprises a bowler's position relative to a reference line, and wherein the bowler corrective feedback application generates the corrective feedback by analyzing the travel path and speed of the bowling ball and the position of the bowler relative to a reference line.

7. A method for providing corrective feedback comprising:
receiving, at a processor, bowler profile data, the bowler profile data identifying one or more bowler characteristics;
receiving, at the processor, bowler game play data from a plurality of pin sensors and a plurality of lane sensors;
generating, at the processor, corrective feedback data based on the bowler profile data and the bowler game play data; and
providing the corrective feedback at a display.

8. The method of claim 7, further comprising receiving bowler game play data from a foul line sensor.

9. The method of claim 7, wherein the display is user interface incorporated into the flat lane surface.

10. The method of claim 7, wherein the display is an electronic mobile device.

11. The method of claim 7, wherein the bowler profile characteristics comprises bowler name, bowler tag, and bowler hand.

12. The method of claim 7, wherein the game play data specifies the travel path and speed of a bowling ball, the game profile data comprises a bowler's position relative to a reference line, and wherein generating the corrective feedback includes analyzing the travel path and speed of the bowling ball and the position of the bowler relative to a reference line.

13. A computer-readable medium encoded with an endorsement rebate application comprising modules executable by a processor comprising:
a game play module to receive bowler profile data, the bowler profile data identifying one or more bowler characteristics of a bowler, and bowler game play data from a plurality of pin sensors and a plurality of lane sensors;
a corrective feedback generation module to generate corrective feedback for the bowler based on the profile data and the bowler game play data; and
a display module to provide the corrective feedback to a display.

14. The computer-readable medium of claim 13, wherein the game play module is further configured to receive bowler game play data from a foul line sensor.

15. The computer-readable medium of claim 13, wherein the display is user interface incorporated into the flat lane surface.

16. The computer-readable medium of claim 13, wherein the display is an electronic mobile device.

17. The computer-readable medium of claim 13, wherein the bowler profile characteristics comprises bowler name, bowler tag, and bowler hand.

18. The computer-readable medium of claim 13, wherein the game play data specifies the travel path and speed of a bowling ball, the game profile data comprises a bowler's position relative to a reference line, and wherein generating the corrective feedback includes analyzing the travel path and speed of the bowling ball and the position of the bowler relative to a reference line.

19. A computerized bowling system for providing corrective feedback to a bowler comprising:
a flat lane surface in communication with a backstop area having a pin sensor area that includes a plurality of pin sensors for representing a particular pin position in the pin sensor area, the backstop area further includes an automatic ball return;
a plurality of lane sensors positioned along the flat lane surface, each of the plurality of lane sensors adapted to detect the travel of a bowling ball along the flat lane surface;
a processor in operative communication with the plurality of sensors and pin sensors for providing data to the processor; and
a monitor in operative communication with the processor for providing corrective feedback based on analysis of the travel of the bowling ball detected by the plurality of sensors and pin sensors, and the position of the bowler relative to a reference line entered into the processor.

20. A method for providing corrective feedback to a user comprising:
a) providing a flat lane surface defining an approach portion and a lane portion with a reference line that divides the lane portion from the approach portion, the lane portion in communication with a backstop area having a pin sensor area that includes a plurality of pin sensors for representing a particular pin position of a plurality of pin positions in the pin sensor area, a plurality of lane sensors positioned along the lane portion, each of the plurality of lane sensors adapted to detect a bowling ball traveling along the lane portion, a processor in operative communication with the plurality of lane sensors and pin sensors for providing data to the processor, a user interface in communication with the processor for permitting the user to interact with the processor, and a monitor in operative communication with the processor for providing a visual display;
b) entering information into the processor related to the bowling ball and a position of a bowler relative to the reference line;
c) rolling a bowling ball along the flat lane surface toward the backstop area;
d) detecting the travel, spin and speed of the bowling ball by the plurality of lane sensors and pin sensors;
e) processing the data related to the travel, spin and speed of the bowing ball as the bowling ball travels along the lane portion as well as the position of the bowler relative to the reference line; and
f) providing corrective feedback via the user interface based on the processed data.
